(19) United States
(12) Patent Application Publication
(10) Pub. No.: US 2026/0316687 A1
(43) Pub. Date: Oct. 15, 2026

(54) VEHICLE REAR-MOUNTED ARTICLE CARRIER ASSEMBLY

(71) Applicant: Re:Car Inc., Troy, MI (US)

(72) Inventors: Jordan Nizza, Long Beach, CA (US); Ben Rowley, Oak Park, MI (US); Tony Bulchak, Hazel Park, MI (US); Henri Kavaja, Laguna Niguel, CA (US); Cesar Estrada Lopez Negrete, Torreon (MX); Thomas Harrington, Culver City, CA (US); Amer Mansour, West Bloomfield, MI (US)

(21) Appl. No.: 19/645,031

(22) Filed: Apr. 10, 2026

Related U.S. Application Data
(60) Provisional application No. 63/786,788, filed on Apr. 10, 2025.

(51) Int. Cl. B60R 9/06

(52) U.S. Cl. CPC B60R 9/065

(57) ABSTRACT

An article carrier assembly for use on an automotive vehicle that has a front end portion and a rear end portion, the vehicle being configured to include a plurality of longitudinally extending frame rails each having an open and hollow rearwardly directed end, a step surface on the frame rail at the open and hollow rearwardly directed end, and a bumper that includes a fascia that at least partially covers the rearwardly directed ends of the frame rails. The article carrier assembly includes a support body that includes a vehicle mount portion configured to attach to the vehicle into the open and hollow rearwardly directed end of at least one frame rail, at least one upwardly oriented arm portion, and a carrier portion.

### CROSS-REFERENCE TO RELATED APPLICATIONS

The present application claims the benefit of the filing date of U.S. Application Ser. No. 63/786,788, filed Apr. 10, 2025, the contents of which is incorporated by reference in its entirety.

### FIELD

These teachings relate to an article carrier assembly for a vehicle, and more particularly to an article carrier assembly configured for providing at least one stowage enclosure, a spare tire assembly, or both on an automotive vehicle that is reversibly configurable between a pickup truck configuration and a sport utility vehicle configuration.

### BACKGROUND

Many current automotive vehicle designs have limited capacity to carry spare tires. On certain vehicles this has driven the need for equipping the vehicles with expensive run-flat tires. One alternative, and a traditional approach, has been to include a temporary spare tire (referred to commonly as a “donut”) that has limited duration often less than about 10 kilometers. Another approach has been to mount a spare tire on a vehicle exterior. For example, it is common to encounter certain off-road capable vehicles with a tailgate mounted spare tire. Such solution typically involves mounting the spare tire and wheel assembly onto a vehicle during original equipment manufacturing, and typically also requires specific hardware and structure located within the tailgate. Examples of efforts to address the above are illustrated in U.S. Pat. Nos. 6,189,748B1, 8,528,800B1, US2023/0415827A1, US2022/0048345A1, US2020/0255072A1, US2019/0241222A1, and US2008/0067200A1, US2008/0047985A1, each of which is expressly incorporated by reference in entirety.

Notwithstanding the above, there remains a need for an improved spare tire carrier system.

### SUMMARY

The above need and others may be met by the present description in which there is contemplated an apparatus, method of using it, and a vehicle on which the apparatus is mounted. More particularly the apparatus may be an article carrier assembly for use on an automotive vehicle that may have a front end portion and a rear end portion and may be configured to include a plurality of longitudinally extending frame rails each having an open and hollow rearwardly directed end, and a step surface on the frame rail at the open and hollow rearwardly directed end, and a bumper that includes a fascia that may at least partially cover the rearwardly directed ends of the frame rails. The article carrier assembly may include a support body that may include a vehicle mount portion configured to attach to the vehicle into the open and hollow rearwardly directed end of at least one frame rail, a carrier portion, and at least one upwardly oriented arm portion to join the vehicle mount portion with the carrier portion.

More particularly, the vehicle mount portion may be configured to be secured at least partially within at least one of the rearwardly directed open and hollow ends of at least one of the longitudinally extending frame rails. The at least one upwardly oriented arm portion may extend from the vehicle mount portion and may be configured for rotation about at least one pivot axis. The carrier portion may be attached to the vehicle mount portion, by ways of the at least one upwardly oriented arm portion, and may be configured to receive and support at least one stowage enclosure and/or a spare tire assembly employing a steel wheel that is decorated with an adhesive mounted polymeric film applique and/or an exposed full-size tire during vehicle operation.

The article carrier assembly may include a removable cover that is configured to co-act with a storage bin, the wheel of the spare tire assembly, or both to define an enclosure capable of carrying articles including tools, emergency indicators, or a first aid kit.

An A-surface of the wheel and the tire may be facing forward and toward the vehicle, and a B-surface of the wheel and the tire may be facing outward and away from the vehicle.

The vehicle mount portion may be configured to be secured to the at least one longitudinal extending frame rail, in which the rail may include the step surface defined by at least one sheet on a top surface of the rail that is wider than a rail width and/or may be laterally offset toward a side of the vehicle relative to a vehicle longitudinal axis, through an opening defined in the bumper fascia.

The vehicle mount portion may be configured to include a forward projecting beam oriented horizontally that may penetrate into at least one longitudinally extending frame rail in a horizontal orientation for defining a mechanical connection via at least three threaded fasteners, clips, pins, cam locks, or clamps, where at least two of which may be oriented at an angle perpendicular to each other and/or at an orientation that is transverse to the orientation of the frame rail and the forward projecting beam. The mechanical connection may be between the forward projecting beam and the frame rail.

The at least one upwardly oriented arm portion may include a lower portion that carries at least part of a hinge subassembly for pivotal rotation about the at least one pivot axis and the at least one upwardly oriented arm portion may include at least part of a latch subassembly to secure the upwardly oriented arm portion in a fixed position during vehicle operation. The at least one upwardly oriented arm portion may include a swing arm that extends from the vehicle mount portion and is configured for manual rotation by a user about the at least one pivot axis to permit clearance of the article carrier assembly away from a vehicle tailgate.

The upwardly oriented arm portion, the carrier portion, or both, may include a rear-view camera assembly, and/or a center high-mounted stop lamp, and/or a spare tire mounting plate, and/or a spare tire bolt plate, and/or a spare tire tube mount collar, and/or wheel fastening elements including bolts and/or lugs, and/or a U-shaped pull handle.

The carrier portion may include a center high-mounted stop lamp, and the center high-mounted stop lamp may be located on a cover that may be part of the at least one stowage enclosure and/or the spare tire assembly during vehicle operation.

The carrier portion may be configured to provide fastening locations for securing one or more components of the at least one stowage enclosure and/or configured to provide the spare tire assembly employing the steel wheel that may be decorated with the adhesive mounted polymeric film applique and/or employing the exposed tire where the tire may be exposed entirely about its outer circumference.

The article carrier assembly may include a combination of the at least one stowage enclosure and the spare tire assembly, the stowage enclosure may include (i) a cover that is dimensioned to cover at least a portion of the wheel of the spare tire assembly, and to which a center high-mounted stop lamp may be attached, and (ii) mounting hardware for securing the spare tire assembly to the article carrier assembly, which may include a spare tire mounting plate, and/or a spare tire bolt plate, and/or a spare tire tube mount collar, and/or wheel fastening elements which may include bolts and/or lugs. The stowage enclosure may include a storage bin that may be configured to receive articles for storage and, during vehicle operation, may be located between the cover and the wheel, directly opposing a B-surface of the wheel, of the spare tire assembly, and/or the storage bin may nest at least partially within the wheel from behind an A-surface.

The cover may include a circular frame and may include a cross bar having an opening to which the center high-mounted stop lamp and/or a rear view camera assembly may be received and may be in electrical communication with a vehicle controller. The cover may include two panels that may be removable from and re-attachable to the circular frame. One or both of the panels of the cover may be secured to the circular frame by a barrel lock that may include a key that may rotate between a first unlocked position and a second locked position.

The storage bin of the article carrier assembly may include an annular flange portion opposite of which the circular frame of the cover may be positioned, a circumferential wall, a base portion and a divider wall that may extend from the base portion at least partially toward the annular flange portion. The divider wall may be covered during vehicle operation by the cover cross bar. The circumferential wall and/or the base portion may include a plurality of ribs.

The vehicle mount portion, the at least one upwardly oriented arm portion, and the carrier portion may be maintained in fixed position relative to each other during vehicle operation by a latch subassembly. The latch subassembly may be positioned to secure the vehicle mount portion directly to the upwardly oriented arm portion to thereby block pivotal rotation. The latch subassembly may include a manually operated latch handle carried by one of the vehicle mount portion or the at least one upwardly oriented arm portion. The latch handle may be configured to cause a locking pin, that may be spring biased and/or may have an engagement projection, to translate from a locked position in an opening in the other of the vehicle mount portion or the at least one upwardly oriented arm portion to an unlocked position.

The any one, two or three of the vehicle mount portion, the at least one upwardly oriented arm portion, and the carrier portion may include a locking guide device which may include one or more opposing ramps of elastic arms. The arms may have a surface for guiding an elongated component into an enlarged opening that may clamp around the elongated component.

A method of assembling a vehicle with the article carrier assembly may include providing an article carrier assembly, inserting the vehicle mount portion into an open and rearwardly directed end of at least one longitudinally extending frame rail of the vehicle through the rear bumper fascia of the vehicle, and mechanically securing the vehicle mount portion to the rail.

The vehicle including the article carrier assembly may be characterized as being reversibly configurable between a pickup truck configuration and a sport utility vehicle configuration. The vehicle including the article carrier assembly may employ an electrical propulsion system without any internal combustion engine. The vehicle including the article carrier assembly may have a pair of longitudinally extending frame rails that each have an open and hollow rearwardly facing end. The vehicle including the article carrier assembly may have a pair of longitudinally extending frame rails that each have an open and hollow rearwardly facing end and a step surface defined by at least one sheet on a top surface of the rail that is wider than a rail width. The vehicle including the article carrier assembly may have a rear bumper fascia that includes at least one removable cover aligned with a longitudinally extending frame rail that has an open and hollow rearwardly facing end.

The article carrier assembly may include a hinge subassembly which may include a position holder element with a detent portion, an elongated rotational element defining the pivot axis, and a pivotally mounted spring biased cam follower proximate the position holder element for contacting the position holder element. An external surface contour of the position holder element may provide a surface structure against which the spring biased cam follower may bear during motion of the carrier portion relative to the vehicle mount portion. As the carrier portion swings toward or away from the vehicle mount portion it may be retained in one or more intermediate locations between a fully open and a fully latched position.

The latch subassembly may include a slam latch which may include the locking pin. The locking pin may be an elongated spring biased pin. The latch subassembly may include the latch handle configured to move the elongated spring biased pin from the locked position to the unlocked position. The latch subassembly may include a locking guide device that may have opposing ramps of elastic arms for receiving an elongated component of the upwardly oriented arm portion.

The latch subassembly may include the latch handle being carried by a cover of the upwardly oriented arm portion and being connected to the locking pin. The latch subassembly may include the engagement projection being fixed relative to the locking pin. The latch handle, the locking pin, and the engagement projection may be rotatable between a locked position and an unlocked position about a pin axis. The engagement projection of the locking pin may create an interference with a slot of the vehicle mount portion when in the locked position. The engagement projection of the locking pin may not create an interference with the slot of the vehicle mount portion when in the unlocked position. The latch subassembly may include a locking guide device that may have opposing ramps of elastic arms for receiving an elongated component of the vehicle mount portion.

The article carrier assembly may be adaptable for use on a vehicle that may be reconfigurable between a pickup truck configuration and a sport utility vehicle configuration. The vehicle may include a frame that may include a front region that may be located generally over a pair of front wheels of the vehicle and a rear region that may be located generally over a pair of rear wheels of the vehicle. The rear region may have a pair of opposing bed walls and a rear floor. The frame may include one or more frame fastening devices. The vehicle may include a rear enclosure assembly that may be configured to attach to the one or more preexisting fasteners on the frame to reconfigure the vehicle from the pickup truck configuration to the sport utility vehicle configuration. The rear enclosure assembly may include a roll bar assembly that may include a hoop structure having a pair of spaced apart pillars, an upper cross bar connected to upper regions of the pillars, and one or more rear passenger seats configured for attachment to the roll bar assembly. The hoop structure may be attached to the opposing bed walls and/or the rear floor of the frame.

### BRIEF DESCRIPTION OF THE DRAWINGS

FIG. 1 is an exploded perspective view of a vehicle with an article carrier assembly of the present teachings.

FIG. 1A is a perspective view of an article carrier assembly of the present teachings.

FIG. 1B is an exploded perspective view of a vehicle with an article carrier assembly of the present teachings.

FIG. 2 is a perspective view of the vehicle with the article carrier assembly of the present teachings and a spare tire mounted thereon.

FIG. 2A is a perspective view of the vehicle with the article carrier assembly of the present teachings and a spare tire mounted thereon.

FIG. 3 is an exploded perspective view of the vehicle with a vehicle mount portion of the present teachings.

FIG. 4 is an exploded perspective view of the vehicle with the vehicle mount portion of the present teachings.

FIG. 5 is an exploded perspective view of the vehicle with the article carrier assembly of the present teachings.

FIG. 6 is an exploded view of a hinge subassembly of the present teachings.

FIG. 6A is an exploded perspective view of a hinge subassembly of the present teachings.

FIG. 6B is a perspective view of a detent portion of the hinge subassembly of the present teachings.

FIG. 6C is a plan view of the hinge subassembly of the present teachings.

FIG. 6D is a cross-sectional view of the hinge subassembly of FIG. 6C.

FIG. 7 is a perspective view of the hinge subassembly of the present teachings.

FIG. 8 is an exploded view of a spare tire assembly of the present teachings.

FIG. 9A is a perspective view of a mechanical interlock of the present teachings.

FIG. 9B is a front view of the mechanical interlock of the present teachings.

FIG. 9C is a perspective view of the mechanical interlock of the present teachings.

FIG. 10 is a perspective view of a latch subassembly of the present teachings.

FIG. 11 is a perspective view of the latch subassembly of the present teachings.

FIG. 12 is a perspective view of a locking guide device of the present teachings.

FIG. 12A is a perspective view of the locking guide device of the present teachings.

FIG. 13 is an exploded view of a portion of the latch subassembly of the present teachings.

FIG. 14A is a perspective view of the latch subassembly of the present teachings.

FIG. 14B is a perspective view of the latch subassembly of the present teachings.

FIG. 14C is a perspective view of the latch subassembly of the present teachings.

### DETAILED DESCRIPTION

The present description relates generally to an article carrier assembly for an automotive vehicle. Though applicable to numerous vehicle types, the article carrier assembly is particularly well suited for use with a vehicle employing an electrical propulsion system (e.g., a battery powered vehicle having no internal combustion engine). Among the vehicles to which the subject of the description may be employed is a vehicle that is reversibly configurable between a pickup truck configuration and a sport utility vehicle configuration.

For example, the article carrier according to this description is suitable for use with and adapted for use with the reconfigurable vehicle in U.S. 63/785,542 filed on Apr. 8, 2025, U.S. 63/788,545 filed on Apr. 14, 2025, U.S. 63/792,518 filed on Apr. 22, 2025, and U.S. Ser. No. 19/642,294 filed on Apr. 8, 2026, the entirety of which are hereby incorporated by reference herein in their entirety for all purposes.

By way of summary, the vehicle for which this article carrier is adapted for can be reconfigured from a first vehicle configuration to a second vehicle configuration. The vehicle can be reconfigured back to the first vehicle configuration. In other words, the vehicle has a reversibly configurable structure. In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

One of the vehicle configurations (e.g., first vehicle configuration or second vehicle configuration) may be a pickup truck or pickup truck configuration. The other vehicle configuration (e.g., first vehicle configuration or second vehicle configuration) may be a sport utility vehicle (SUV) or SUV configuration.

A “pickup truck” includes a vehicle that may be a light, medium-duty or heavy-duty truck. The pickup truck configuration may include a vehicle having an enclosed cab or cockpit (for at least a driver and at least one occupant) and an open cargo area, namely a bed, located in the rear portion of the vehicle and being operable for storing, hauling and/or transporting cargo. A pickup truck configuration may be a vehicle that does not include a C-pillar, e.g., does not include a C-pillar that defines part of a passenger cab. A pickup truck configuration may be a vehicle that does not include a D-pillar. A pickup truck configuration may be a vehicle that has a removable bulkhead panel and rear window or glass assembly that can be completely removed or separated from the vehicle.

A “sport utility vehicle” includes a vehicle that may be a light, medium-duty or heavy-duty vehicle including an enclosed cab (for at least a driver and at least one and preferably a plurality of occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C-and D-pillars may be added. The SUV configuration may have a substantially horizontal roof with a substantially vertical rear hatch, or the SUV configuration may have a substantially horizontal roof with a sloped rear hatch (e.g., a “fastback” configuration).

In the context of the present description, “original equipment” includes automotive vehicles and their respective components in a state as assembled during the construction of the vehicles as new vehicles. In contrast, “aftermarket” equipment includes components made by companies other than the original equipment manufacturer, which might be installed as replacements or enhancements after the car comes out of the factory. Article carriers of the present description may be provided as components of original equipment vehicle, and/or provided as aftermarket equipment for installation on an original equipment vehicle (optionally using at least some of the hardware provided in the original equipment vehicle).

“Sport utility vehicle” is not intended to be limited to any particular chassis construction and may include a vehicle that has a unibody construction, a body-on-frame construction, or any other construction.

In the context of the present description, an automotive vehicle may be reversibly configurable between a pickup truck configuration and a sport utility vehicle configuration. In this regard, the reversible configuration may enable conversion from one configuration to the other with non-destructive techniques, e.g., with detachment, relocation, and re-attachment of some or all components by use, for instance, of mechanical disconnection and connection techniques (e.g., by use of reversible mechanical fastening such as unfastening original equipment vehicle hardware, optionally repositioning a component and/or installing an additional component, and re-fastening at least some of the original equipment vehicle hardware). The attachment locations at which reversible mechanical fasteners are employed may be at locations predetermined by the original equipment manufacturer, and/or using hardware provided by the original equipment manufacturer for the purpose of enabling reconfiguration of the vehicle.

The vehicle may have a front end portion (e.g., having a forward cargo compartment), a rear end portion (e.g., adjoining a cargo bed and/or having a tailgate at its end), an upper portion, and a lower portion (e.g., a portion that is beneath a cargo bed floor of the vehicle, and which may also include a bottom side of the vehicle). The vehicle may include a frame. In particular, a “frame” may refer to a vehicle portion, shell, or skeleton that imparts structural integrity to the vehicle, whether to the entire vehicle and/or a portion only of the vehicle. A frame typically is a part of the vehicle that provides support for one or more vehicle body panels, interior components, possibly some corner assemblies that include a brake assembly, and/or a part of the vehicle to which other vehicular components can be attached and/or mounted. For example, one or more interior vehicle components (e.g., interior panels, vehicle seats, dashboard, etc.) of the vehicle may be attached or supported on the frame. For example, one or more exterior vehicle components (e.g., exterior body panels, a wheel, a tire, doors, lights, windows, etc.) of the vehicle may be attached or supported on the frame. A frame may include one or a plurality of subframes. The subframes may be configured to absorb energy and have a controlled impact response in the event of a small overlap frontal impact and/or a direct frontal impact. The frame may include structural components such as A-pillars, B-pillars, floor, and cargo area walls. In some configurations, one or more elements of the frame may be permanently connected together such as via welding, riveting, and/or adhesive bonding. The vehicle frame or structural components of the vehicle frame may be made of a high strength architecture made of metal, aluminum, and/or steel. The frame may include a plurality of fastener elements (e.g., weld nuts, self-clinching nuts, blind rivet nuts, rivets or other threaded inserts) located at predefined locations and configured to receive another fastener element for attaching vehicle components (e.g., body panels, article carriers, or the like) to the frame.

The vehicle frame may include a plurality of longitudinally extending rails. The plurality of longitudinally extending rails may be part of the lower portion of the vehicle and may extend from the vehicle rear toward the vehicle front in the direction of a longitudinal axis of the vehicle. The plurality of frame rails may be laterally offset toward a side of the vehicle relative to a vehicle longitudinal axis. The rails may include tubular portions (e.g., having one or more of a rectangular, circular, hexagonal or other cross-sectional shape). The rails may include tubular portions that each may have an open and hollow rearwardly directed end.

At the rearwardly directed end, there may also be included one or more step surfaces. For example, on top of the rear ends, there may be a sheet formed on or attached to the rail end that extends laterally beyond the rail width to provide a larger surface onto which a user may step when using the vehicle. The vehicle may include a pair of longitudinally extending frame rails that each have an open and hollow rearwardly facing end and a step surface defined by at least one sheet on a top surface of the rail that is wider than a rail width. The vehicle may include a bumper fascia. The bumper fascia may at least partially cover the rearwardly directed ends of the frame rails. The bumper fascia may include cutouts and removable cutout covers. Cutouts may be longitudinally axially aligned with the rearwardly directed ends of the frame rails. Thus, in one state, cutout covers are secured to the bumper fascia, and may at least partially (if not fully) conceal the rearwardly directed ends of the frame rails. In another state (e.g., for installing the article carrier assembly of the present description), the cutout covers are removed to expose the rearwardly directed ends of the frame rails.

In general, the article carrier assembly may include a vehicle mount portion configured to attach to the vehicle or frame into the open and hollow rearwardly directed end of at least one frame rail, a carrier portion, and optionally at least one upwardly oriented arm portion to join the vehicle mount portion with the carrier portion.

With more particularity, an article carrier assembly of the present description may include a support body that includes a vehicle mount portion, a pivotal arm portion, and an article carrying portion. More particularly, there may be a vehicle mount portion that is configured to be secured at least partially within at least one of the rearwardly directed open and/or hollow ends of at least one of the longitudinally extending frame rails. There may be a pivotal arm portion that includes at least one upwardly oriented arm portion extending from the vehicle mount portion and being configured for rotation about at least one pivot axis. The pivotal arm portion may be integrated as part of the vehicle mount portion or the article carrying portion. The article carrying portion may include a carrier portion attached to the at least one upwardly oriented arm portion and being configured to receive and support at least one stowage enclosure, a spare tire assembly (preferably one employing a steel wheel that is optionally decorated with an adhesive mounted polymeric film applique and/or an exposed full-size tire having the same configuration as the four vehicle wheels), or both (e.g., via a keyed connection that may transmit torque and prevent relative rotation between the carrier portion and the at least one stowage enclosure and/or the spare tire assembly) during vehicle operation and/or preferably employing an uncovered tire (e.g., the tire is exposed about its circumference (e.g., entirely about its outer circumference)) or a combination of both). In a preferred mode when mounted, the A-surface of the wheel and tire, meaning the outwardly facing surface, is facing forward and toward the vehicle, and the B-surface of the wheel and tire is facing outward and away from the vehicle. As will be addressed in further detail, the assembly may also include a removable cover that is configured to co-act with a storage bin, a wheel of a spare tire assembly, or both to define an enclosure capable of carrying articles (e.g., tools, emergency indicators, first aid kit, or the like). Various electrical components may be run through any component of the article carrier assembly.

The vehicle mount portion may be configured to be secured to at least one longitudinally extending frame rail. For instance, the vehicle mount portion may be configured to penetrate into a hollow and open end in at least one longitudinally extending frame rail. As noted, the frame rail may include a step surface (e.g., at its rearward end). The step surface may be defined, for instance, by attaching a sheet on a top surface of the rail that is wider than a rail width.

The vehicle mount portion may be configured to include one or more forward projecting beams that penetrate into the open end of the at least one longitudinally extending frame rail for defining a mechanical connection. For example, a projecting beam may penetrate into the open end of one of the longitudinally extending frame rails for defining a mechanical connection. By way of another example, two projecting beams may penetrate into the open ends of two of the longitudinally extending frame rails, respectively, for defining a mechanical connection. The connection may be realized in a removable manner. For example, there may be one or more threaded fasteners that penetrate one or more aligned through holes in both the forward projecting beam and the frame rail (e.g., forward projecting beam through holes and frame rail through holes). The through holes may be on a top wall of the frame rail (e.g., frame rail through holes) and of the forward projecting beam (e.g., forward projecting beam through holes). The through hole may be on a side wall of the frame rail (e.g., frame rail through holes) and of the forward projecting beam (e.g., forward projecting beam through holes). One approach may be to use a plurality of such fastening arrangements, at least three fasteners, at least two of which oriented at an angle (perpendicular or otherwise) to each other, and/or at an orientation that is transverse to the orientation of the frame rail and the forward projecting beam. The fasteners may be inserted at an angle that is transverse to the orientation of the frame rail and the forward projecting beam. Other orientations of the fasteners are also possible provided that they afford structural stability to the assembly and/or they preferably include a plurality of fasteners at least two of which are oriented at an angle of 30-90 degrees relative to each other. Other fastening techniques may be used such as clips, pins, cam locks, clamps, or the like to arrive at a suitable connection between the forward projecting beam and the frame rail.

Turning to the at least one upwardly oriented arm portion, it may include a first portion (e.g., a lower portion) that optionally carries a hinge subassembly for allowing a pivotal rotation about the at least one pivot axis. Additionally or alternatively, the hinge subassembly may be carried by the vehicle mount portion. The hinge subassembly may define the pivot axis and optionally may include a position holder element to hold in a predetermined position the carrier portion (and/or the upwardly oriented arm portion) relative to the vehicle mount portion. The hinge subassembly may form a connection between the vehicle mount portion and the upwardly oriented arm portion and/or the carrier portion. For example, part of the hinge subassembly may be part of the vehicle mount portion. The hinge subassembly may include an elongated rotational element (e.g., a vertically oriented pin or bolt) defining the pivot axis. The elongated rotational element may penetrate into, and preferably through, a position holder element (e.g., an element that may be cylindrical or that otherwise may at least partially surround (if not fully) the elongated rotational element along at least part of the elongated rotational element length). Carried on, proximate to, or as part of the position holder element may be detent portion that provides an external surface contour. The external surface contour is configured to provide a plurality of successive radially outward projections and detent recesses. A spring biased cam follower may be mounted proximate to the position holder element for contacting the position holder element. The external surface contour of the detent portion, and thus the position holder element, thus provides a surface structure against which the spring biased cam follower can bear during motion of the carrier portion and/or upwardly oriented arm portion relative to the vehicle mount portion. In this manner as the carrier portion and/or the upwardly oriented arm portion swings toward or away from the vehicle mount portion, the carrier portion and/or the upwardly oriented arm portion may be retained in one or more intermediate locations between a fully open and fully latched position.

In an example, the spring biased cam follower may be spring biased via a torsional spring. The spring biased cam follower may be mounted proximate the position holder element for contacting the position holder element by a fastener that allows pivotal motion of the spring biased cam follower. The hinge subassembly may include a clevis having an upper wall and a lower wall. A hinge cover may conceal the clevis and may be fastened to the hinge subassembly via a suitable fastener. A portion of the position holder element may be located within the clevis and may rotate around the elongated rotational element. A portion of the fastener that allows pivotal motion of the spring biased cam follower may be located in the clevis.

By way of another example, the spring biased cam follower may be spring biased via a leaf spring. The leaf spring of the spring biased cam follower may be a cantilevered arm that may extend from a side wall of the spring biased cam follower and may extend partially downward to contact the detent portion. The hinge subassembly may have a housing (e.g., substantially tubular housing) with an opening (e.g., a tubular opening) extending about the pivot axis. The spring biased cam follower may include an elongated portion having an opening (e.g., a tubular opening) extending about the pivot axis and extending upward and into the opening (e.g., tubular opening) of the housing. The housing may have a lower projection that may be configured to mate with a corresponding follower opening of the spring biased cam follower creating a keyed connection that may transmit torque and prevent relative rotation between the spring biased cam follower and the housing. Thus, if the housing rotates, the spring biased cam follower may rotate with the housing. The lower projection and the follower opening may be non-circular (e.g., square, rectangular, hexagonal, or the like). Preferably, the lower projection and the follower opening may be generally rectangular where the two shorter sides of the generally rectangular shape may be convexly curved outward. The elongated rotational element may also penetrate into and through the opening (e.g., tubular opening) of the housing and the opening (e.g., tubular opening) of the elongated portion. The position holder element may include two separate structures, one being the detent portion and the other being a base. The base may be coupled to the vehicle mount portion and may include an upper projection that may be configured to mate with a corresponding detent opening in the detent portion creating a keyed connection that transmits torque and prevents relative rotation between the base and the detent portion. The upper projection and the detent opening may be non-circular (e.g., square, rectangular, hexagonal, or the like). Preferably, the upper projection and the detent opening may be generally rectangular where the two shorter sides of the generally rectangular shape may be convexly curved outward. The elongated rotational element may penetrate into and through the position holder element, and may thus penetrate into and through the base and the detent portion. The elongated rotational element may be threadably engaged with the base which may prevent relative motion between the base and the elongated rotational element. The spring biased cam follower may be mounted above the detent portion for contacting the detent portion. The spring biased cam follower and/or the detent portion may be a unitary structure that is molded of a polymer, preferably a polymer (e.g., polyoxymethylene, polytetrafluoroethylene, polyether ether ketone, and/or a polyolefin (e.g., polyethylene)) exhibiting a relatively low coefficient of friction (e.g., ranging from 0.1 to 0.4 for steel). A portion of the hinge subassembly (e.g., the housing) may be coupled to the upwardly oriented arm portion. Thus, if the upwardly oriented arm portion rotates, the housing may rotate with the upwardly oriented arm portion. It is envisioned by the present teachings that the housing and the spring biased cam follower may be one structure (e.g., a female structure) and/or the base, the detent portion, and the elongated rotational element may be one structure (e.g., a male structure).

The at least one upwardly oriented arm portion may include a latch subassembly to secure the upwardly oriented arm portion in a fixed position during vehicle operation. The at least one upwardly oriented arm portion may include a swing arm that extends from the vehicle mount portion and is configured for manual rotation by a user about the at least one pivot axis. In this manner, by pivoting the at least one upwardly oriented arm portion, a user should be able to realize a clearance of the article carrier assembly relative to the vehicle tailgate. The upwardly oriented arm portion and/or the carrier portion may include a center high-mounted stop lamp which may be optionally located on a cover that is part of least one stowage enclosure, a spare tire assembly, or both during vehicle operation.

In regard to the carrier portion, it may be configured to provide fastening locations for securing an article. In particular, it may provide fastening locations for one or more components of a stowage enclosure, a spare tire assembly, or a combination of both. A spare tire assembly may employ a wheel (e.g., a steel wheel) that is optionally decorated with an adhesive mounted polymeric film applique. The spare tire assembly may employ a full-size tire mounted thereon.

The upwardly oriented arm portion, the carrier portion, or both, may be configured to carry, support or otherwise include other vehicle components, such as a rear-view camera assembly, and/or an electrical light (e.g., a center high-mounted stop lamp), and/or a spare tire mounting plate, and/or a spare tire bolt plate, and/or a spare tire tube mount collar, and/or wheel fastening elements (e.g., bolts and/or lugs), and/or a pull handle (e.g., a U-shaped pull handle) with or without a cover trim. The spare tire mounting plate and the spare tire bolt plate may sandwich the wheel, and the spare tire tube mount collar may extend into a hub of the wheel.

Turning to the utility of the article carrier, due to its unique arrangement and function, the assembly may include a combination of a stowage enclosure and a spare tire assembly. By way of illustration, the stowage enclosure may include (i) a cover that is dimensioned to cover at least a portion (if not all of) of a wheel of the spare tire assembly, and to which a center high-mounted stop lamp optionally is attached. The stowage enclosure may include mounting hardware for securing the spare tire assembly to the article carrier assembly. By way of example, there may be included a spare tire mounting plate, and/or a spare tire bolt plate, and/or a spare tire tube mount collar, and/or wheel fastening elements such as bolts and/or lugs. The stowage enclosure may include a storage bin that is configured to receive articles for storage and, during vehicle operation, is located between the cover and the wheel of the spare tire assembly. For example, the wheel may have an outer side or A-surface, and preferably an inner side or B-surface. When mounted on the article carrier assembly, in an installed state, the wheel may have its A-surface facing toward the vehicle, and the storage bin may thus be directly opposite the B-surface of the wheel. The storage bin thus may nest at least partially within the wheel from behind the A-surface.

In order to realize the above, it is envisioned that the cover may include a circular frame. A cross bar may bisect the circular frame. In combination with the circular frame, the cross bar may define at least one, if not two or more openings. For example, the cross bar may have at least one receptacle to receive a vehicle component, for example, a center high-mounted stop lamp, a rear-view camera assembly, or both. The crossbar may be equipped with suitable electrical connectors so that any component it receives can be signally connected with the vehicle (e.g., in electrical communication with a vehicle controller).

The cover may include at least one panel, and preferably two panels, that are removable from and re-attachable to the circular frame. Additionally or alternatively, the panels may fold out from the circular frame and/or include a hinge connecting them to the circular frame. Upon removal, there may be a passage (e.g., windows) through the circular frame. The circular frame may have at least one mechanical interlock, and preferably two mechanical interlocks, to secure the at least one panel to the circular frame. Preferably, the at least one mechanical interlock is a rotatable latch or a barrel lock. One or both of the panels of the cover may be releasably secured to the circular frame. For example, a rotatable latch may include a handle that rotates between a first unlocked position and a second locked position to drive a blocking member of the rotatable latch to resist pull-out from at least one panel. By way of another example, a barrel lock may include a key that rotates between a first unlocked position and a second locked position to drive a blocking member of the barrel lock to resist pull-out from at least one panel.

Next, for use to define a stowage compartment the article carrier assembly may employ a storage bin that includes an annular flange portion. The annular flange portion may be located opposite of which the cover (e.g., the circular portion of the cover) is positioned. The storage bin may include a circumferential wall, a base portion, and optionally a divider wall that extends from the base portion at least partially (if not fully) toward the annular flange portion. The divider wall being covered during vehicle operation by the cover, preferably by the cover cross bar. The circumferential wall, the base portion, or both may include a plurality of ribs.

The article carrier assembly may carry a tire that is not covered, or that is exposed about its circumference (e.g., entirely about its outer circumference).

The vehicle mount portion, the at least one upwardly oriented arm portion, and the carrier portion desirably may be maintained in fixed position relative to each other during vehicle operation. This may be achieved by a mechanical interference such as by, for example, a latch subassembly. The latch subassembly may be positioned to secure the vehicle mount portion directly to the upwardly oriented arm portion and/or the carrier portion to thereby block pivotal rotation. The upwardly oriented arm portion and/or the latch subassembly may include a cover which may have an inclined upper wall in a direction toward the vehicle.

In one example, the latch subassembly may include a slam latch which may include a locking pin, preferably a spring biased pin, having a rounded distal end and being reciprocally movable between an extended latched position (e.g., locked position) and a retracted unlatched position (e.g., unlocked position) along a pin axis. The latch subassembly may also include a latch handle, which may be manually operated, configured for moving the pin against the force of the spring. The latch handle may be part of either the carrier portion or the upwardly oriented arm portion (e.g., the cover). The latch subassembly may also include a plate having a first face and an opposing second face, a plurality of contiguous side edges, and an opening along at least one of the side edges to receive the pin. The plate may be part of the vehicle mount portion. The latch subassembly may also include a spring biased latch center release member including a free end that is rotatable about an axis parallel to the pin axis. The spring biased (e.g., via a torsion spring) latch center release member may include a detent at the free end, preferably shaped as a hook. The detent at the free end may have an inner and/or an outer edge that defines a cam against which the pin may bear for causing pivotal rotation of the spring biased latch center release member.

The latch subassembly may also include a locking guide device attached to the vehicle mount portion and configured to include a mechanical interlock device. For example, the locking guide device may be attached to an attachment plate. The locking guide device may include opposing ramps of spaced apart elastic arms. The arms may have a surface for guiding an elongated component, preferably a bar, of the carrier portion or the upwardly oriented arm portion, into an enlarged opening that clamps around the elongated component (e.g., interference fit, snap fit, etc.). The locking guide device may be at least partially made of a polymer, preferably a polymer (e.g., polyoxymethylene, polytetrafluoroethylene, polyether ether ketone, and/or a polyolefin (e.g., polyethylene)) exhibiting a relatively low coefficient of friction (e.g., ranging from 0.1 to 0.4 for steel). The locking guide device may act as a stabilizer for reducing movement between elements.

For enabling the article carrier assembly to rotate about its pivot axis, upon retracting the latch handle, the pin is released from a locked position in which the center release member is biased to retain the pin from moving out of the opening of the plate in a direction away from the vehicle mount portion due to the detent of the center release member.

There may be two modes for enabling the article carrier assembly to secure the carrier portion or the upwardly oriented arm portion with the vehicle mount portion. One mode may be while the latch handle is in a retracted position, the elongated component of the carrier portion or the upwardly oriented arm portion may be advanced toward the vehicle mount portion and onto the opposing ramps of the elastic arms that clamp around the elongated component. Following that and release of the latch handle, the rounded distal end of the pin (e.g., from a position above the plate opening) may bear against the inner edge of the release member and force the release member to rotate and receive the pin in a position that resists movement in a direction away from the vehicle mount portion.

The other mode may be while the latch handle is not in a retracted position, the elongated component of the carrier portion or the upwardly oriented arm portion may be advanced toward the vehicle mount portion and onto the opposing ramps of the elastic arms that clamp around the elongated component, and the pin (e.g., from a position at a side of the plate opening) may bear against the outer edge of the release member to rotate and receive the pin in a position that resists movement in a direction away from the vehicle mount portion.

In another example, the latch subassembly may include a locking pin that may be reciprocally movable between a latched (e.g., locked) position and an unlatched (e.g., unlocked) position about a pin axis. The locking pin may have an engagement projection that may be fixed relative to the locking pin (e.g., via a keyed connection that transmits torque and prevents relative rotation between the locking pin and the engagement projection, or the locking pin and the engagement projection may be one unitary structure), and the engagement projection may be configured to create an interference with a slot. The locking pin and/or the engagement projection may be carried by (e.g., part of) the upwardly oriented arm portion (e.g., the cover) or the carrier portion. The slot may be part of the vehicle mount portion (e.g., via an L-shaped bracket, having the slot on its lower portion, that may be fastened to (e.g., via at least one fastener) the vehicle mount portion). The latch subassembly may also include a latch handle that may be carried by (e.g., part of) the upwardly oriented arm portion (e.g., the cover) or the carrier portion. The latch handle may be manually operated. The latch handle may be connected to the locking pin and configured to rotate the locking pin and the engagement projection between a latched (e.g., locked) position and an unlatched (e.g., unlocked) position about a locking pin axis.

The latch subassembly also includes a locking guide device that may be attached to either the carrier portion or the upwardly oriented arm portion. The locking guide device may be configured to include a mechanical interlock device. The locking guide device may include opposing ramps of elastic arms. The arms may have a surface for guiding an elongated component, preferably a bar, of the vehicle mount portion, into an enlarged opening that may clamp around the elongated component (e.g., interference fit, snap fit, etc.). The locking guide device may be at least partially made of a polymer, preferably a polymer (e.g., polyoxymethylene, polytetrafluoroethylene, polyether ether ketone, and/or a polyolefin (e.g., polyethylene)) exhibiting a relatively low coefficient of friction (e.g., ranging from 0.1 to 0.4 for steel). The locking guide device may act as a stabilizer for reducing movement between elements.

For enabling the article carrier assembly to rotate about its pivot axis, upon rotating the latch handle, the pin and the engagement projection may be released from a locked position. In the locked position, the engagement projection of the locking pin may create an interference with the slot of the vehicle mount portion which may prevent movement of the pin and the engagement projection in a direction away from the vehicle mount portion. To release the latch subassembly from a locked position to an unlocked position, a user may rotate the latch handle, thus rotating the locking pin and the engagement projection, so that the engagement projection of the locking pin may not create an interference with the slot of the vehicle mount portion which may allow movement of the pin and the engagement projection in a direction away from the vehicle mount portion.

Also within the scope of the present teachings is a method of assembling a vehicle with an article carrier assembly. In general, such method may include providing an article carrier assembly as described herein. The vehicle mount portion may be inserted into an open and hollow rearwardly facing end of at least one longitudinally extending frame rail of the vehicle. For example, the vehicle mount portion may be inserted into an open and hollow rearwardly facing end of at least one longitudinally extending frame rail of the vehicle through a rear bumper fascia of the vehicle, or the vehicle mount portion may be concealed by the bumper fascia. The method may also include a step of mechanically securing the vehicle mount portion to the rail. The method may be free of any step of permanent modification of the vehicle (e.g., without any step of drilling and/or cutting). The method may be free of any step of attaching the article carrier assembly into a transversely extending cross-car bumper structure. The method may be free of any step of attaching the article carrier assembly to an exterior body panel (e.g., a tailgate outer panel, and/or a rear fender panel). The method may be free of any step of welding. It may be envisioned by the present teachings that the vehicle mount portion may be connected to the upwardly oriented arm portion and the carrier portion during installation on the vehicle. It may also be envisioned by the present teachings that the vehicle mount portion may not be connected to, and may be a separate structure from, the upwardly oriented arm portion and/or the carrier portion during installation on the vehicle. In this case, a user may insert and secure the vehicle mount portion to the vehicle as described above, where the vehicle mount portion includes the base, the detent portion, and the elongated rotational element of the hinge subassembly (e.g., which may be one male structure). The user may connect the upwardly oriented arm portion and/or the carrier portion to the vehicle mount portion via the hinge subassembly. For example, the user may slide the housing and the spring biased cam follower (e.g., which may be one female structure) onto the elongated rotational element of the hinge subassembly.

The use of the present teachings makes it possible to secure an article carrier assembly to a vehicle without using a trailer hitch receiver of the vehicle, without removal and/or replacement of an original equipment bumper beam, and/or without any welding. The use of the present teachings makes it possible to avoid attaching the article carrier assembly into a transversely extending cross-car bumper structure. The use of the present teachings makes it possible to avoid attaching the article carrier assembly to an exterior body panel (e.g., a tailgate outer panel, and/or a rear fender panel).

These teachings are applicable to a spare tire assembly that includes wheel that has a wheel face onto which a graphic design applique is supported. The graphic design applique may function to allow a user or owner to alter or otherwise customize a function of the wheel, and/or an aesthetic appearance of the wheel(s), vehicle, or both. The wheel may be used as a part with a vehicle that has a braking system utilizing regenerative braking, electro-mechanical braking, or hydraulic braking.

Turning now to the drawings to more particularly illustrate examples of the present description.

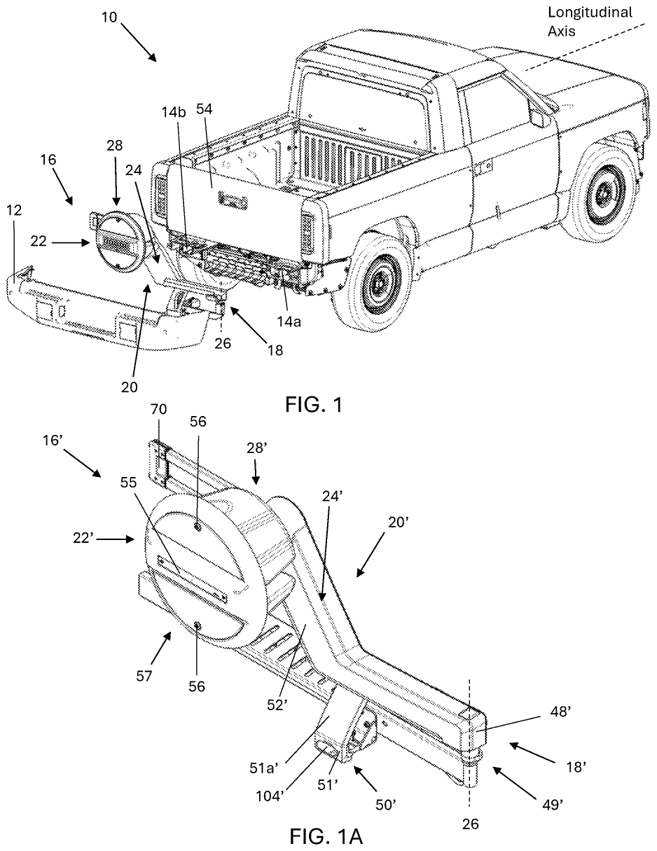

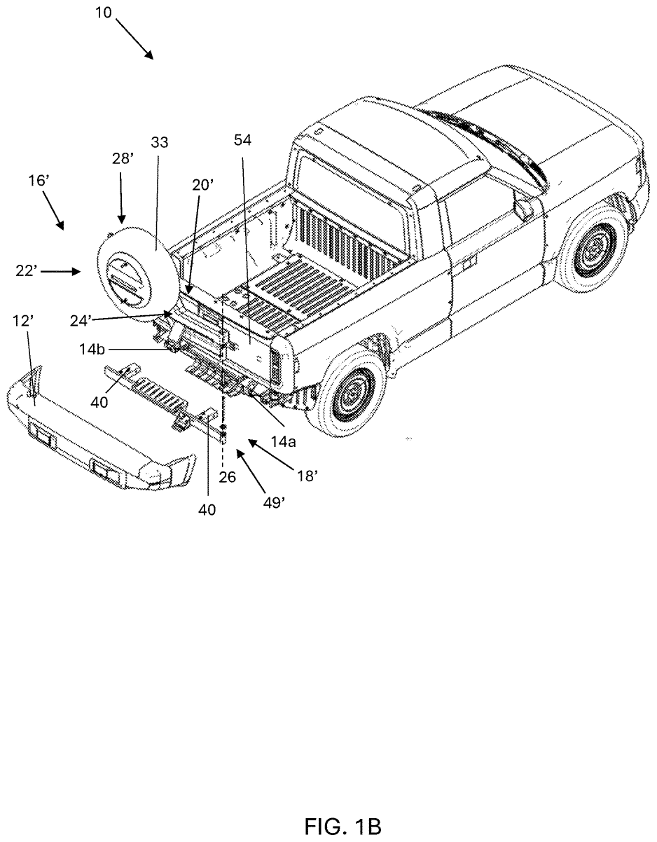

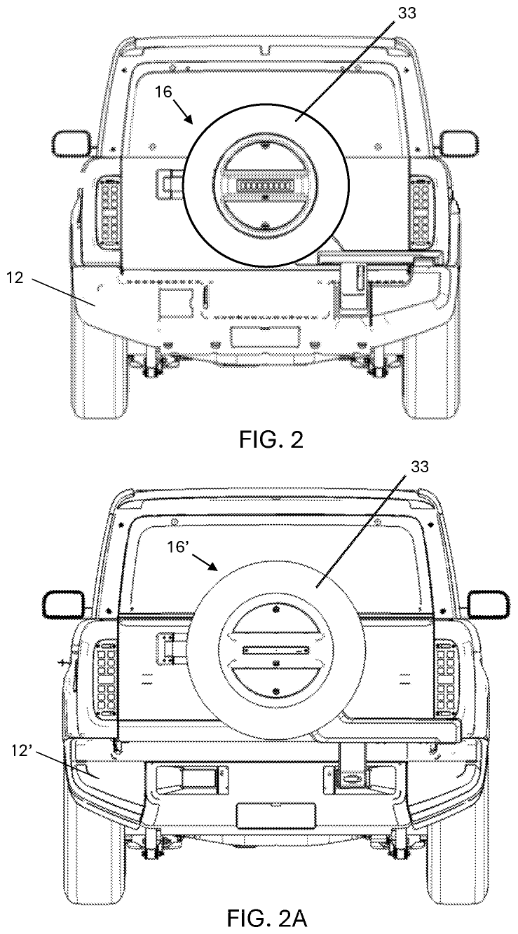

Turning to FIGS. 1, 1B, 2, and 2A, there is depicted a perspective view of a vehicle 10 with a bumper fascia 12/12′. The vehicle 10 has two longitudinally extending frame rails (e.g., a first frame rail 14a and a second frame rail 14b that extend from the vehicle rear toward the vehicle front in the direction of a longitudinal axis of the vehicle).

In FIGS. 1, 1A, 1B, 2, and 2A, there is also depicted an article carrier assembly 16/16′ which includes a support body that includes a vehicle mount portion 18/18′, a pivotal arm portion 20/20′, and an article carrying portion 22/22′. The pivotal arm portion 20/20′ includes an upwardly oriented arm portion 24/24′ extending from the vehicle mount portion 18/18′ which is configured to rotate about a pivot axis 26. The pivotal arm portion 20/20′ may be integrated as part of the vehicle mount portion 18/18′ or the article carrying portion 22/22′.

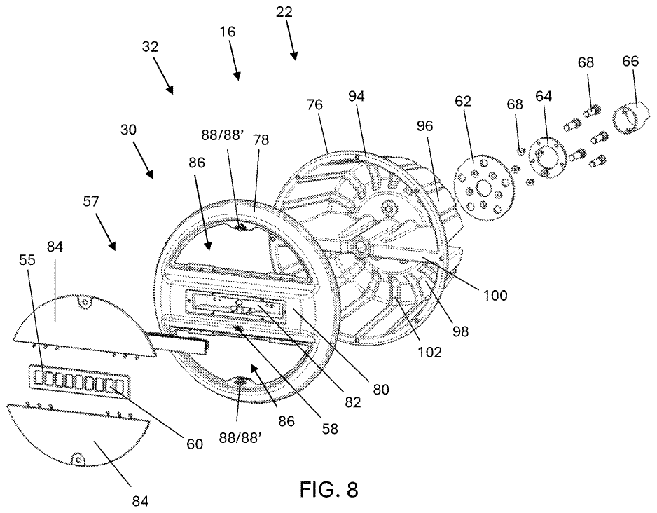

The article carrying portion 22/22′ includes a carrier portion 28/28′ attached to the upwardly oriented arm portion 24/24′ which is configured to receive and support a stowage enclosure 30 and a spare tire assembly 32 (FIG. 8). The spare tire assembly 32 supports an uncovered tire 33 (FIGS. 1B, 2, 2A), which preferably is a full-size vehicle tire mounted on a wheel that has the same configuration as the four vehicle wheels. In a preferred mode when mounted, the A-surface of the wheel and tire, meaning the outwardly facing surface, is facing forward and toward the vehicle, and the B-surface of the wheel and tire is facing outward and away from the vehicle. The spare tire assembly 32 also includes a removable cover 57 that is configured to co-act with a storage bin 76 and/or a wheel of the spare tire assembly 32 which defines an enclosure capable of carrying articles (e.g., tools, emergency indicators, first aid kit, or the like) (FIG. 8). Although bumper fascia 12 is shown with article carrier assembly 16, it is envisioned by the present teachings that bumper fascia 12′ may be used with article carrier assembly 16. Similarly, bumper fascia 12 may be used with article carrier assembly 16′.

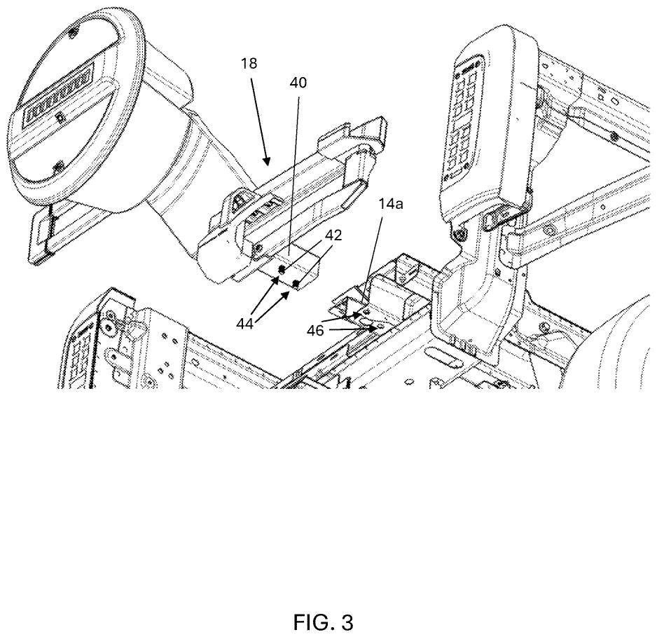

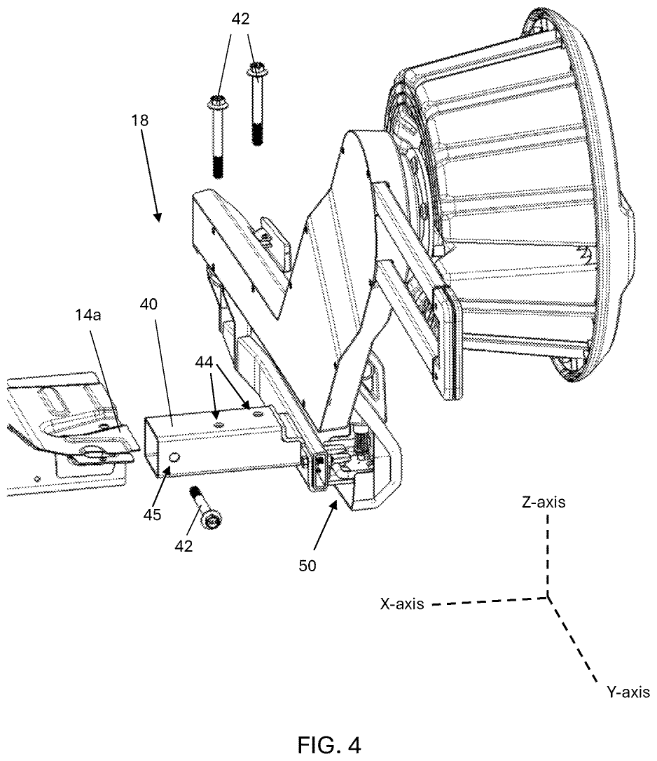

Turning now to FIGS. 3 and 4, the vehicle mount portion 18 is configured to be secured to the vehicle 10 within a frame rail 14a (e.g., a first frame rail 14a or a second frame rail 14b). There is depicted a forward projecting beam 40 of the vehicle mount portion 18. The forward projecting beam 40 penetrates into the open and hollow end of frame rail 14a and defines a mechanical connection. There are depicted two fasteners 42 that penetrate forward projecting beam through holes 44 and frame rail through holes 46 from above at an angle that is transverse (e.g., shown as parallel to the Z-axis of FIG. 4) to the longitudinal axis (e.g., X-axis of FIG. 4) of the frame rail 14a and the forward projecting beam 40. In FIG. 4, there is depicted one fastener 42 that penetrates a forward projecting beam through hole 45 and frame rail through hole (not shown) from the side at an angle that is transverse (e.g., shown as parallel to the Y-axis of FIG. 4) to the longitudinal axis (e.g., X-axis of FIG. 4) of the frame rail 14a and the forward projecting beam 40. Other orientations of the fasteners are also possible provided that they afford structural stability to the assembly and/or they preferably include a plurality of fasteners at least two of which are oriented at an angle of 30-90 degrees relative to each other. Vehicle mount portion 18′ is shown in FIG. 1B with two forward projecting beams 40 configured to be secured to the vehicle 10 within both frame rails (e.g., the first frame rail 14a and the second frame rail 14b). The forward projecting beams 40 of the vehicle mount portion 18′ are substantially similar to those described above with regard to the vehicle mount portion 18 and they connect to the vehicle 10 in a substantially similar manner as described above.

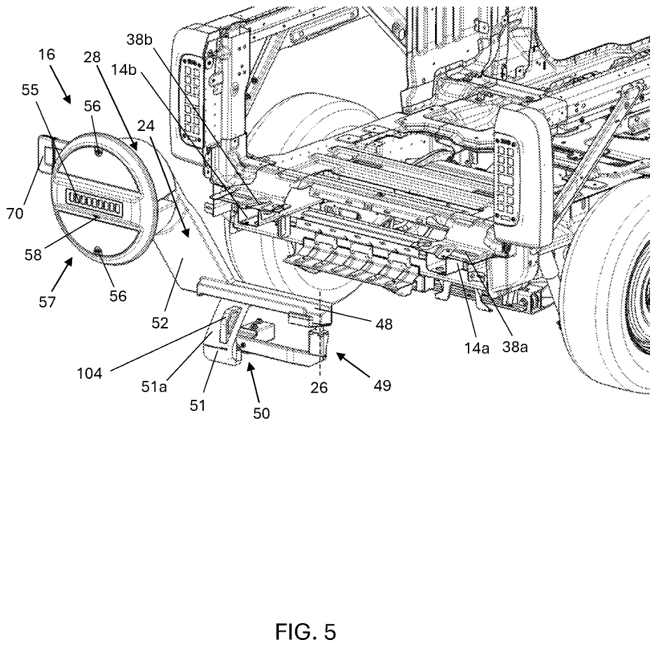

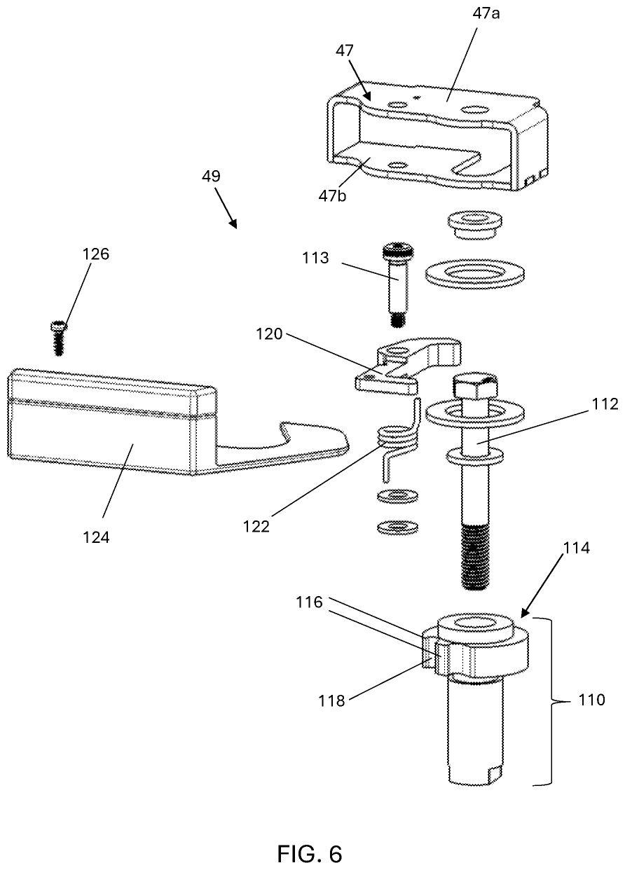

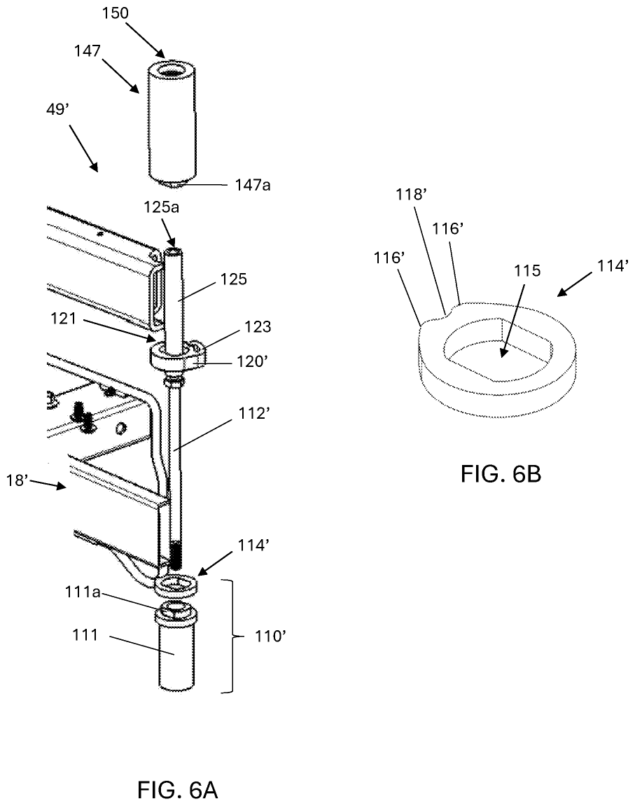

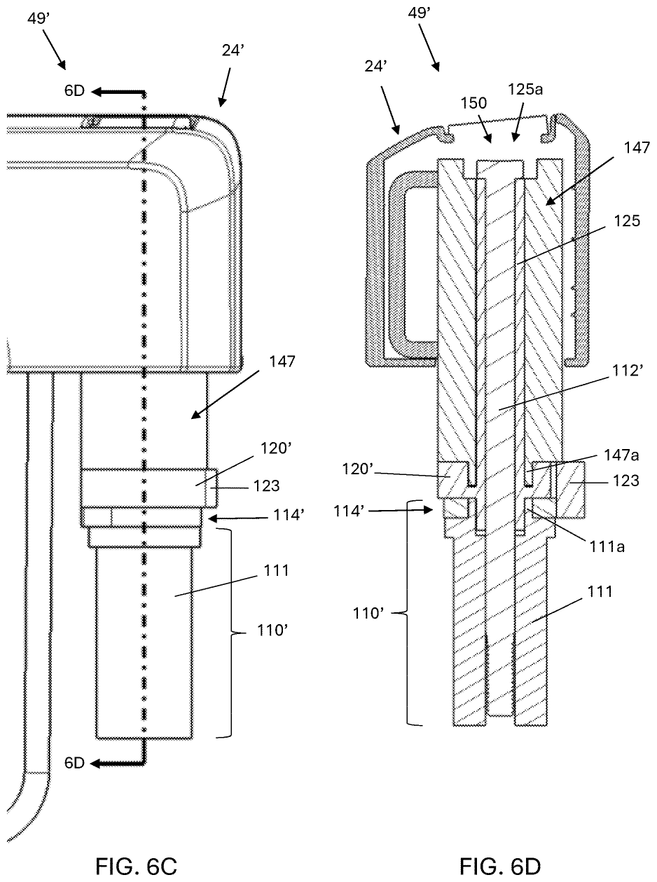

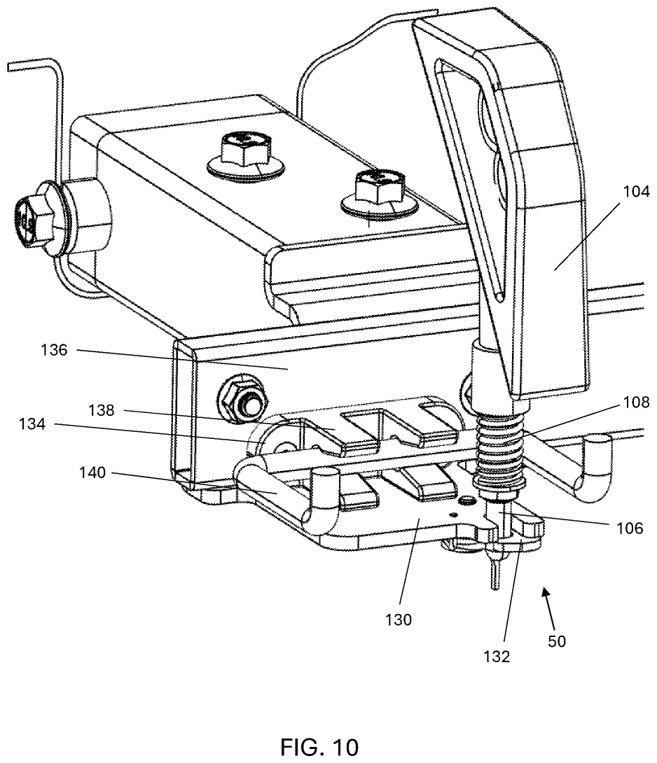

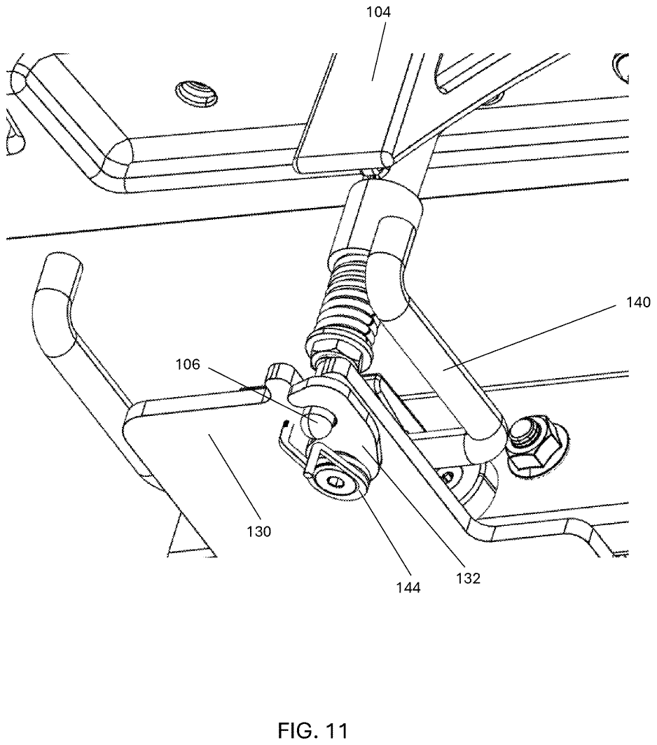

Turning to FIGS. 1A and 5, there is depicted a step surface 38a, 38b on the top surface of the frame rail 14a, 14b. The upwardly oriented arm portion 24/24′ may include a lower portion 48/48′ that has a hinge subassembly 49/49′ (FIGS. 6, 6A-6D show in more detail) for allowing pivotal rotation about the pivot axis 26. The upwardly oriented arm portion 24/24′ includes a latch subassembly 50/50′ (more detail shown in FIGS. 10 and 11, 14A-14C), including a cover 51/51′ (shown in FIGS. 1A and 5 as having an inclined upper wall 51a/51a′ in a direction toward the vehicle 10), to secure the upwardly oriented arm portion 24/24′ in a fixed position during vehicle operation. The upwardly oriented arm portion 24/24′ includes a swing arm 52/52′, at least partially L-shaped (e.g., as an ice hockey stick) that extends from the vehicle mount portion 18/18′ and is configured for manual rotation by a user about the pivot axis 26 defined by a hinge subassembly 49/49′ (shown in more detail in FIGS. 6, 6A-6D). In this manner, by pivoting the upwardly oriented arm portion 24/24′, a user should be able to realize a clearance of the article carrier assembly 16/16′ relative to a vehicle tailgate 54 (FIGS. 1, 1B). The carrier portion 28/28′ includes a center high-mounted stop lamp 55 that is located on a cover 57 that is part of the stowage enclosure 30 and/or the spare tire assembly 32 (FIG. 8). The carrier portion 28/28′ has two fastening locations 56 for components of a stowage enclosure 30 and/or the spare tire assembly 32 (FIG. 8) to secure an article. There is also depicted a pull handle 70, a latch handle 104/104′ for latch subassembly 50/50′, and the hinge subassembly 49/49′ (FIGS. 6, 6A-6D shows in more detail).

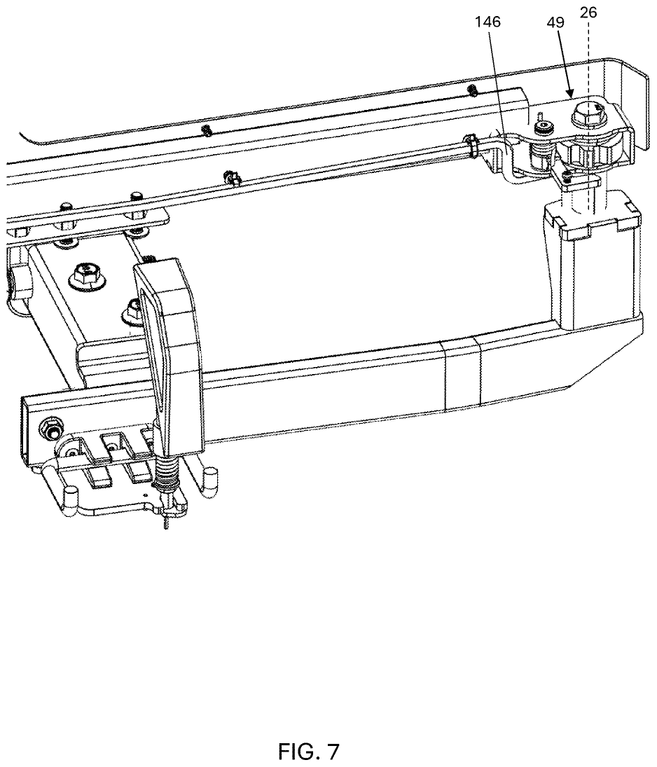

Turning to FIGS. 6, 6A, 6C, 6D, and 7, there is depicted hinge subassembly 49/49′ for allowing pivotal rotation about the pivot axis 26. The hinge subassembly 49/49′ includes a hinge that defines the pivot axis 26 and a position holder element 110/110′ to hold in a predetermined position the carrier portion 28/28′ and the upwardly oriented arm portion 24/24′ relative to the vehicle mount portion 18/18′. The hinge subassembly 49/49′ forms a connection between the vehicle mount portion 18/18′ and the upwardly oriented arm portion 24/24′. Part of the hinge subassembly is part of the vehicle mount portion 18/18′. The hinge subassembly 49/49′ includes an elongated rotational element 112/112′ defining the pivot axis 26. The elongated rotational element 112/112′ penetrates into and through the position holder element 110/110′. Part of the position holder element 110/110′ is a detent portion 114/114′ that provides an external surface contour. The external surface contour of the detent portion 114/114′ provides a plurality of successive radially outward projections 116/116′ and detent recesses 118/118′ (FIGS. 6, 6B). A spring biased (e.g., via a torsional spring 122 shown in FIG. 6, via a leaf spring 123 shown in FIGS. 6A, 6C, 6D) cam follower 120/120′ is mounted proximate to the position holder element 110/110′ for contacting the position holder element 110/110′. The external surface contour thus provides a surface structure against which the spring biased cam follower 120/120′ can bear during motion of the carrier portion 28/28′ and/or the upwardly oriented arm portion 24/24′ relative to the vehicle mount portion 18/18′. In this manner, as the carrier portion 28/28′ and/or the upwardly oriented arm portion 24/24′ swings toward or away from the vehicle mount portion 18/18′ the carrier portion 28/28′ and/or the upwardly oriented arm portion 24/24′ can be retained in one or more intermediate locations between a fully open and fully latched position.

FIG. 6 shows that the spring biased cam follower 120 rotates around fastener 113. The hinge subassembly 49 also has a clevis 47 having an upper wall 47a and a lower wall 47b. A hinge cover 124 conceals the clevis 47 and may be fastened to the hinge subassembly 49 via a suitable fastener 126. A portion of position holder element 110 is located within the clevis 47 and rotates around the elongated rotational element 112. A portion of fastener 113 is located in the clevis 47.

FIGS. 6A, 6B, 6C, and 6D show that the hinge subassembly 49′ also has a housing 147 that is substantially tubular with a tubular opening 150 extending about the pivot axis 26. The spring biased cam follower 120′ also includes an elongated portion 125 having a tubular opening 125a extending about the pivot axis 26 and extending upward and into the tubular opening 150 of the housing 147. The housing 147 has a lower projection 147a that is configured to mate with a corresponding follower opening 121 of the spring biased cam follower 120′ creating a keyed connection that transmits torque and prevents relative rotation between the spring biased cam follower 120′ and the housing 147. Thus, if the housing 147 rotates, the spring biased cam follower 120′ rotates with the housing 147. The lower projection 147a and the follower opening 121 are generally rectangular where the two shorter sides of the generally rectangular shape are convexly curved outward. The elongated rotational element 112′ also penetrates into and through the tubular opening 150 (FIG. 6B) of the housing 147 and the tubular opening 125a of the elongated portion 125. The position holder element 110′ includes two separate structures, one being the detent portion 114′ and the other being a base 111. The base 111 is coupled to the vehicle mount portion 18′ and includes an upper projection 111a that is configured to mate with a corresponding detent opening 115 in the detent portion 114′ creating a keyed connection that transmits torque and prevents relative rotation between the base 111 and the detent portion 114′. The upper projection 111a and the detent opening 115 are generally rectangular where the two shorter sides of the generally rectangular shape are convexly curved outward. The elongated rotational element 112′ penetrates into and through the position holder element 110′, and thus penetrates into and through the base 111 and the detent portion 114′. The elongated rotational element 112′ is threadably engaged with the base 111 preventing relative motion between the base 111 and the elongated rotational element 112′. The spring biased cam follower 120′ is mounted above the detent portion 114′ for contacting the detent portion 114′. The leaf spring 123 of the spring biased cam follower 120′ is a cantilevered arm that extends from a side wall of the spring biased cam follower 120′ and extends partially downward to contact the detent portion 114′. FIGS. 6C and 6D show that a portion of the hinge subassembly 49′ is coupled to the upwardly oriented arm portion 24′. Thus, if the upwardly oriented arm portion 24′ rotates, the housing 147 rotates with the upwardly oriented arm portion 24′.

FIG. 7 depicts a torsion bar 146 of article carrier assembly 16 that may provide a spring action (e.g., absorbing energy from impacts). Article carrier assembly 16′ may include a similar torsion bar.

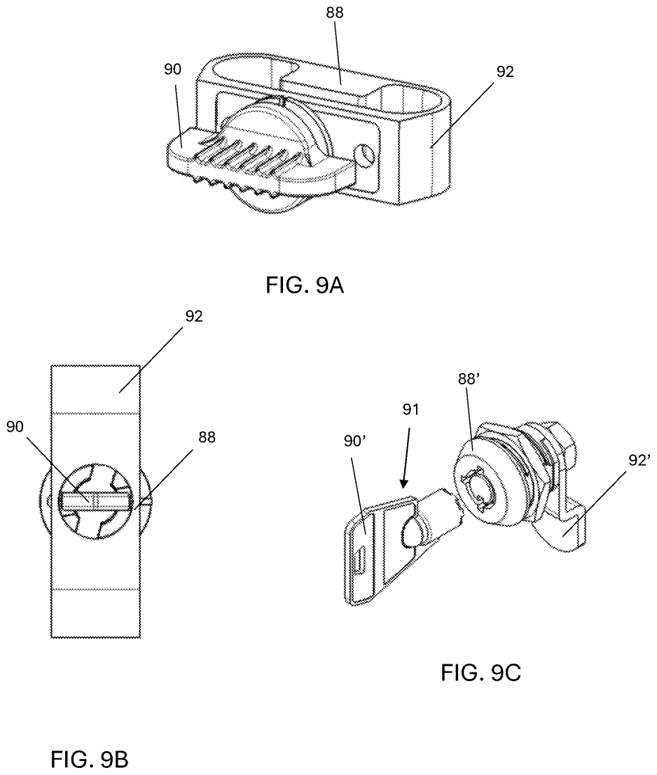

Turning to FIG. 8, there is depicted a spare tire assembly 32 without the full-size tire 33 and wheel mounted. FIG. 8 shows components configured to be secured to an article carrier portion 16/16′. This includes a rear-view camera assembly 58, an electrical light 60, a spare tire mounting plate 62, a spare tire bolt plate 64, a spare tire tube mount collar 66, and wheel fastening elements 68. The spare tire mounting plate 62 and the spare tire bolt plate 64 are configured to sandwich the wheel, and the spare tire tube mount collar 66 is configured to extend into the hub of the wheel. The stowage enclosure 30 includes a cover 57 that is dimensioned to cover at least a portion of a wheel of the spare tire assembly 32. A center high-mounted stop lamp 55 is attached to the cover 57. The spare tire assembly 32 includes mounting hardware for securing to the article carrier assembly 16/16′ including a spare tire mounting plate 62, a spare tire bolt plate 64, a spare tire tube mount collar 66, and wheel fastening elements 68 such as bolts and/or lugs. The stowage enclosure 30 may include a storage bin 76 that is configured to receive articles for storage and is configured to be located between the cover 57 and the wheel of the spare tire assembly 32. The cover 57 has a circular frame 78 and a cross bar 80 bisects the circular frame 78. The cross bar 80 has a receptacle 82 to receive the center high-mounted stop lamp 55 and the rear-view camera assembly 58. The cover 57 has two panels 84 that are removable from and re-attachable to the circular frame 78. The circular frame 78 has two openings 86 aligned with the two panels 84. The storage bin 76 has an annular flange portion 94, a circumferential wall 96, a base portion 98, and a divider wall 100 that extends from the base portion 98 toward the annular flange portion 94. The divider wall 100 is covered by the cross bar 80 of the cover 57. The circumferential wall 96 and the base portion 98 include ribs 102. The circular frame 78 has two mechanical interlocks 88/88′ (detail in FIGS. 9A, 9B, 9C) to secure the two panels 84 to the circular frame 78.

Turning to FIGS. 9A, 9B, and 9C, there is depicted the mechanical interlock 88/88′. The mechanical interlock 88 in FIGS. 9A and 9B is a rotatable latch which includes a handle 90 that rotates between a first unlocked position and a second locked position (shown in FIG. 9B) to drive a blocking member 92 of the rotatable latch 88 to resist pull-out from the panels 84. The mechanical interlock 88′ in FIG. 9C is a barrel lock that includes a handle 90′ of a key 91 that rotates between a first unlocked position and a second locked position to drive a blocking member 92′ of the barrel lock to resist pull-out from the panels 84.

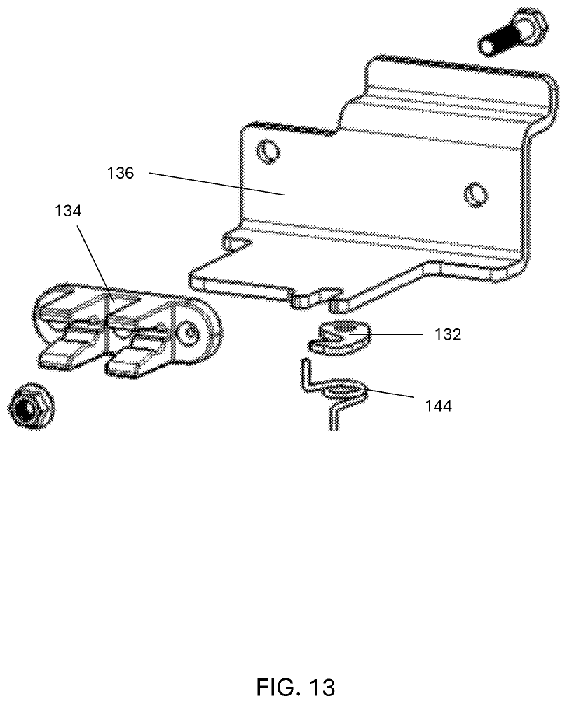

Turning to FIGS. 10-13, there is depicted a latch subassembly 50. The latch subassembly 50 includes a slam latch including a locking pin 106, specifically a spring biased pin, having a rounded distal end and being reciprocally movable between an extended latched position (e.g., locked position) and a retracted unlatched position (e.g., unlocked position) along a pin axis. The latch subassembly 50 also includes a latch handle 104, which may be manually operated, configured for moving the pin 106 against the force of the spring 108. The latch handle 104 may be part of either the carrier portion 28 or the upwardly oriented arm portion 24. The latch subassembly 50 also includes a plate 130 having a first face and an opposing second face, a plurality of contiguous side edges, and an opening along at least one of the side edges to receive the pin 106. The plate 130 is part of the vehicle mount portion 18. The latch subassembly 50 also includes a spring biased latch center release member 132 including a free end that is rotatable about an axis parallel to the pin axis. The spring biased (e.g., via a torsion spring 144) latch center release member 132 includes a detent at the free end, preferably shaped as a hook. The detent at the free end may have an inner and/or an outer edge that defines a cam against which the pin 106 may bear for causing pivotal rotation of the spring biased latch center release member 132.

The latch subassembly 50 may also includes a locking guide device 134 attached to the vehicle mount portion 18 and configured to include a mechanical interlock device. For example, the locking guide device 134 is attached to an attachment plate 136. The locking guide device 134 includes opposing ramps of elastic arms 138. The arms 138 may have a surface for guiding an elongated component 140, preferably a bar, of the upwardly oriented arm portion 24, into an enlarged opening 142 that clamps around the elongated component 140 (e.g., interference fit, snap fit, etc.). The locking guide device 134 may act as a stabilizer for reducing movement between elements.

For enabling the article carrier assembly 16 to rotate about its pivot axis 26, upon retracting the latch handle 104, the pin 106 is released from a locked position in which the center release member 132 is biased to retain the pin 106 from moving out of the opening of the plate 130 in a direction away from the vehicle mount portion 18 due to the detent of the center release member 132.

There may be two modes for enabling the article carrier assembly 16 to secure the carrier portion 28 or the upwardly oriented arm portion 24 with the vehicle mount portion 18. One mode may be while the latch handle 104 is in a retracted position, the elongated component 140 of the carrier portion 28 or the upwardly oriented arm portion 24 may be advanced toward the vehicle mount portion 18 and onto the opposing ramps of the elastic arms 138 that clamp around the elongated component 140. Following that and release of the latch handle 104, the rounded distal end of the pin 106 (e.g., from a position above the plate opening) may bear against the inner edge of the release member 132 and force the release member 132 to rotate and receive the pin 106 in a position that resists movement in a direction away from the vehicle mount portion 18.

The other mode may be while the latch handle 104 is not in a retracted position, the elongated component 140 of the carrier portion 28 or the upwardly oriented arm portion 24 may be advanced toward the vehicle mount portion 18 and onto the opposing ramps of the elastic arms 138 that clamp around the elongated component 140, and the pin 106 (e.g., from a position at a side of the plate opening) may bear against the outer edge of the release member 132 to rotate and receive the pin 106 in a position that resists movement in a direction away from the vehicle mount portion 18.

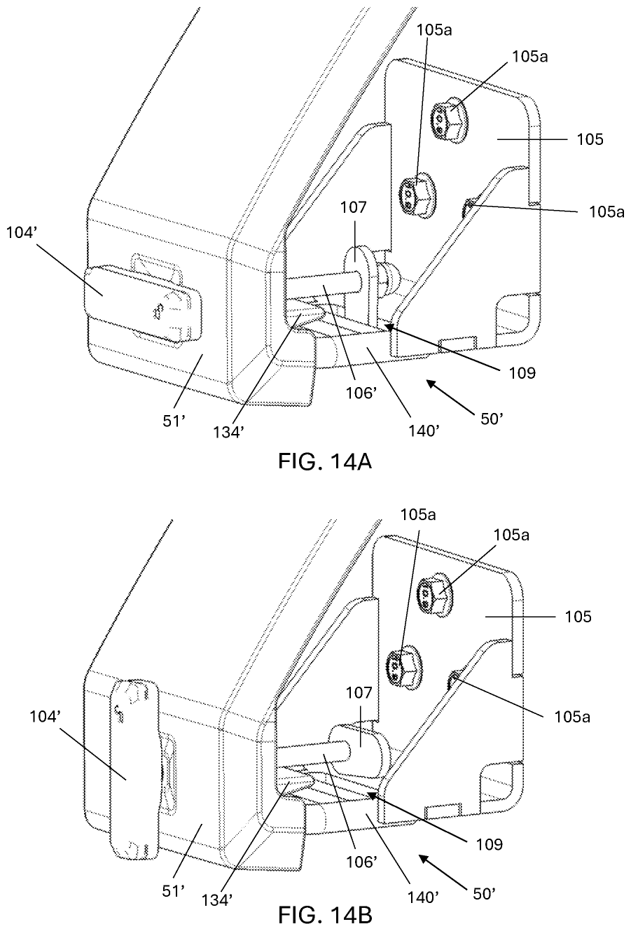

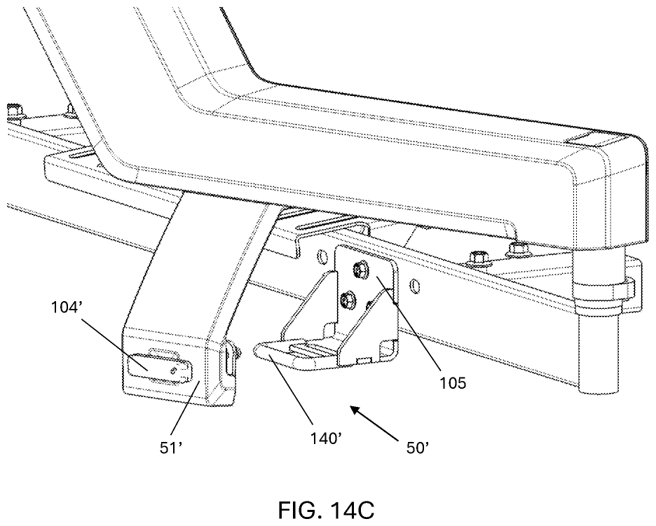

Turning to FIGS. 14A-14C, there is depicted a latch subassembly 50′. The latch subassembly 50′ may include a locking pin 106′, having an engagement projection 107 that is fixed relative to the locking pin 106′ and configured to create an interference with a slot 109 of the vehicle mount portion 18′, and being reciprocally movable between a latched (e.g., locked) position and an unlatched (e.g., unlocked) position about a pin axis. The locking pin 106′ and/or the engagement projection 107 are carried by the cover 51′ of the upwardly oriented arm portion 24′. The slot 109 is part of the vehicle mount portion 18′ via an L-shaped bracket 105 having the slot 109 on its lower portion, where the L-shaped bracket 105 is fastened to the vehicle mount portion 18′ via a plurality of fasteners 105a. The latch subassembly 50′ also includes a latch handle 104′ carried by the cover 51′ of the upwardly oriented arm portion 24′, which may be manually operated, connected to the locking pin 106′ and configured to rotate the locking pin 106′ and the engagement projection 107 between a latched (e.g., locked) position and an unlatched (e.g., unlocked) position about a pin axis.

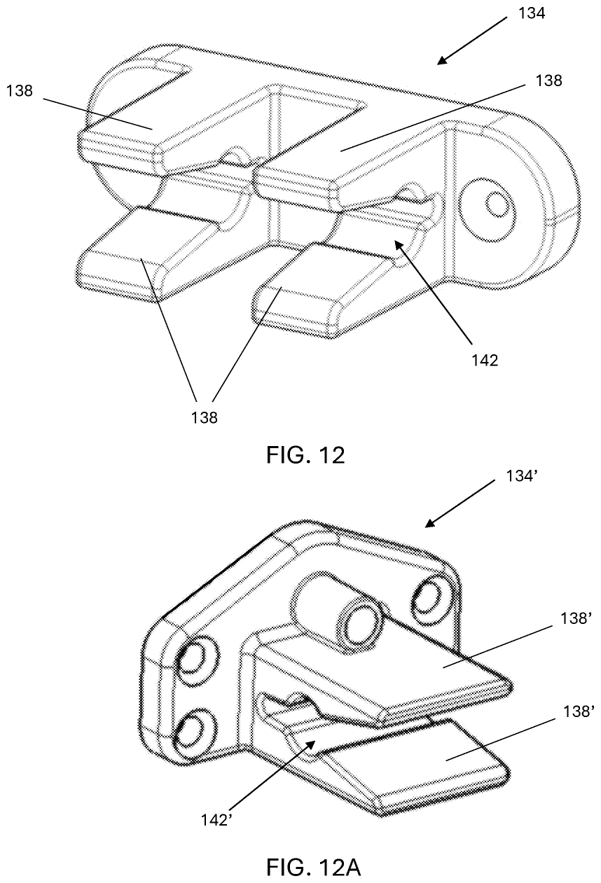

The latch subassembly 50′ also includes a locking guide device 134′ (shown in greater detail in FIG. 12A) attached to the cover 51′ of the upwardly oriented arm portion 24′ and configured to include a mechanical interlock device. The locking guide device 134′ my includes opposing ramps of elastic arms 138′. The arms 138′ have a surface for guiding an elongated component 140′, preferably a bar, of the vehicle mount portion 18′, into an enlarged opening 142′ that clamps around the elongated component 140′ (e.g., interference fit, snap fit, etc.). The locking guide device 134′ may act as a stabilizer for reducing movement between elements.

For enabling the article carrier assembly 16′ to rotate about its pivot axis 26, upon rotating the latch handle 104′, the pin 106′ and the engagement projection 107 are released from a locked position. In the locked position, the engagement projection 107 of the locking pin 106′ creates an interference with the slot 109 of the vehicle mount portion 18′ preventing movement of the pin 106′ and the engagement projection 109 in a direction away from the vehicle mount portion 18′. To release the latch subassembly 50′ from a locked position to an unlocked position, a user rotates the latch handle 104′, thus rotating the locking pin 106′ and the engagement projection 107, so that the engagement projection 107 of the locking pin 106′ does not create an interference with the slot 109 of the vehicle mount portion 18′ allowing movement of the locking pin 106′ and the engagement projection 107 in a direction away from the vehicle mount portion 18′.

It is envisioned by the present teachings that elements with similar reference numerals differentiated by a prime symbol, (e.g., 16/16′) may be interchanged in any of the above illustrative examples.

The article carrier assembly of the teachings herein is adaptable for use on a vehicle that is reconfigurable between a pickup truck configuration and a sport utility vehicle (SUV) configuration, comprising: a frame comprising a front region that is located generally over a pair of front wheels of the vehicle and a rear region that is located generally over a pair of rear wheels of the vehicle, rear region having a pair of opposing bed walls and a rear floor, wherein frame comprises one or more frame fastening devices; a rear enclosure assembly configured to attach to the one or more preexisting fasteners on the frame to reconfigure the vehicle from the pickup truck configuration to the SUV configuration, the rear enclosure assembly comprising: i) a roll bar assembly comprising a hoop structure having a pair of spaced apart pillars, an upper cross bar connected to upper regions of the pillars, and optionally a lower cross bar connected to lower regions of the pillars; and ii) one or more rear passenger seats configured for attachment to the roll bar assembly; wherein the hoop structure is attached to the opposing bed walls and/or the rear floor of the frame. Such a vehicle is illustrated and described in U.S. 63/785,542 filed on Apr. 8, 2025, U.S. 63/788,545 filed on Apr. 14, 2025, U.S. 63/792,518 filed on Apr. 22, 2025, and U.S. Ser. No. 19/642,294 filed on Apr. 8, 2026, the entirety of which are hereby incorporated by reference herein in their entirety for all purposes.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference in their entirety for all purposes. Other combinations are also possible as will be gleaned from the following claims, which are also hereby incorporated by reference into this written description.

1. An article carrier assembly for use on an automotive vehicle that has a front end portion and a rear end portion and is configured to include a plurality of longitudinally extending frame rails each having an open and hollow rearwardly directed end, and a step surface on the frame rail at the open and hollow rearwardly directed end, and a bumper that includes a fascia that at least partially covers the rearwardly directed ends of the frame rails, comprising:
a) a support body that includes:
i) a vehicle mount portion configured to be secured at least partially within at least one of the rearwardly directed open and hollow ends of at least one of the longitudinally extending frame rails;
ii) at least one upwardly oriented arm portion extending from the vehicle mount portion and being configured for rotation about at least one pivot axis; and
iii) a carrier portion attached to the vehicle mount portion, by ways of the at least one upwardly oriented arm portion, and being configured to receive and support at least one stowage enclosure and/or a spare tire assembly employing a steel wheel that is decorated with an adhesive mounted polymeric film applique and/or an exposed full-size tire during vehicle operation.

2. The article carrier assembly of claim 1, wherein the assembly includes a removable cover that is configured to co-act with a storage bin, the wheel of the spare tire assembly, or both to define an enclosure capable of carrying articles including tools, emergency indicators, or a first aid kit.

3. The article carrier assembly of claim 1, wherein an A-surface of the wheel and the tire is facing forward and toward the vehicle, and a B-surface of the wheel and the tire is facing outward and away from the vehicle.

4. The article carrier assembly of claim 1, wherein the vehicle mount portion is configured to be secured to the at least one longitudinally extending frame rail, in which the rail includes the step surface defined by at least one sheet on a top surface of the rail that is wider than a rail width and/or is laterally offset toward a side of the vehicle relative to a vehicle longitudinal axis, through an opening defined in the bumper fascia.

5. The article carrier assembly of claim 1, wherein the vehicle mount portion is configured to include a forward projecting beam oriented horizontally that penetrates into at least one longitudinally extending frame rail in a horizontal orientation for defining a mechanical connection via at least three threaded fasteners, clips, pins, cam locks, or clamps, wherein at least two of which are oriented at an angle perpendicular to each other and/or at an orientation that is transverse to the orientation of the frame rail and the forward projecting beam, and wherein the mechanical connection is between the forward projecting beam and the frame rail.

6. The article carrier assembly of claim 1, wherein the at least one upwardly oriented arm portion includes a lower portion that carries at least part of a hinge subassembly for pivotal rotation about the at least one pivot axis and the at least one upwardly oriented arm portion includes at least part of a latch subassembly to secure the upwardly oriented arm portion in a fixed position during vehicle operation, and the at least one upwardly oriented arm portion includes a swing arm that extends from the vehicle mount portion and is configured for manual rotation by a user about the at least one pivot axis to permit clearance of the article carrier assembly away from a vehicle tailgate.

7. The article carrier assembly of claim 1, wherein the upwardly oriented arm portion, the carrier portion, or both, includes a rear-view camera assembly, and/or a center high-mounted stop lamp, and/or a spare tire mounting plate, and/or a spare tire bolt plate, and/or a spare tire tube mount collar, and/or wheel fastening elements including bolts and/or lugs, and/or a U-shaped pull handle.

8. The article carrier assembly of claim 1, wherein the carrier portion includes a center high-mounted stop lamp, and the center high-mounted stop lamp is located on a cover that is part of the at least one stowage enclosure and/or the spare tire assembly during vehicle operation.

9. The article carrier assembly of claim 1, wherein the carrier portion is configured to provide fastening locations for securing one or more components of the at least one stowage enclosure and/or configured to provide the spare tire assembly employing the steel wheel that is decorated with the adhesive mounted polymeric film applique and/or employing the exposed tire wherein the tire is exposed entirely about its outer circumference.

10. The article carrier assembly of claim 1, the article carrier assembly including a combination of the at least one stowage enclosure and the spare tire assembly, the stowage enclosure including (i) a cover that is dimensioned to cover at least a portion of the wheel of the spare tire assembly, and to which a center high-mounted stop lamp is attached, and (ii) mounting hardware for securing the spare tire assembly to the article carrier assembly, including a spare tire mounting plate, and/or a spare tire bolt plate, and/or a spare tire tube mount collar, and/or wheel fastening elements including bolts and/or lugs, and the stowage enclosure including a storage bin that is configured to receive articles for storage and, during vehicle operation, is located between the cover and the wheel, directly opposing a B-surface of the wheel, of the spare tire assembly, and/or the storage bin nests at least partially within the wheel from behind an A-surface.

11. The article carrier assembly of claim 10, wherein the cover includes a circular frame and includes a cross bar having an opening to which the center high-mounted stop lamp and/or a rear view camera assembly are received and are in electrical communication with a vehicle controller, and the cover includes two panels that are removable from and re-attachable to the circular frame, and wherein one or both of the panels of the cover are secured to the circular frame by a barrel lock that includes a key that rotates between a first unlocked position and a second locked position.

12. The article carrier assembly of claim 11, wherein the storage bin of the article carrier assembly includes an annular flange portion opposite of which the circular frame of the cover is positioned, a circumferential wall, a base portion and a divider wall that extends from the base portion at least partially toward the annular flange portion, the divider wall being covered during vehicle operation by the cover cross bar, and further wherein the circumferential wall and/or the base portion include a plurality of ribs.

13. The article carrier assembly of claim 1, wherein the vehicle mount portion, the at least one upwardly oriented arm portion, and the carrier portion are maintained in fixed position relative to each other during vehicle operation by a latch subassembly, and the latch subassembly is positioned to secure the vehicle mount portion directly to the upwardly oriented arm portion to thereby block pivotal rotation, and/or the latch subassembly includes a manually operated latch handle carried by one of the vehicle mount portion or the at least one upwardly oriented arm portion, the latch handle being configured to cause a locking pin, that is spring biased and/or has an engagement projection, to translate from a locked position in an opening in the other of the vehicle mount portion or the at least one upwardly oriented arm portion to an unlocked position.

14. The article carrier assembly of claim 1, wherein the any one, two or three of the vehicle mount portion, the at least one upwardly oriented arm portion, and the carrier portion include a locking guide device which includes one or more opposing ramps of elastic arms, the arms having a surface for guiding an elongated component into an enlarged opening that clamps around the elongated component.

15. A method of assembling a vehicle with an article carrier assembly comprising, providing an article carrier assembly of claim 1, inserting the vehicle mount portion into an open and rearwardly directed end of at least one longitudinally extending frame rail of the vehicle through the rear bumper fascia of the vehicle, and mechanically securing the vehicle mount portion to the rail.

16. A vehicle including an article carrier assembly of claim 1, wherein the vehicle is characterized as being reversibly configurable between a pickup truck configuration and a sport utility vehicle configuration, and/or employs an electrical propulsion system without any internal combustion engine, and/or has a pair of longitudinally extending frame rails that each have an open and hollow rearwardly facing end and/or has a pair of longitudinally extending frame rails that each have an open and hollow rearwardly facing end and a step surface defined by at least one sheet on a top surface of the rail that is wider than a rail width, and/or has a rear bumper fascia that includes at least one removable cover aligned with a longitudinally extending frame rail that has an open and hollow rearwardly facing end.

17. The article carrier assembly of claim 1, further comprising a hinge subassembly comprising, a position holder element including a detent portion, an elongated rotational element defining the pivot axis, and a pivotally mounted spring biased cam follower proximate the position holder element for contacting the position holder element; wherein an external surface contour of the position holder element provides a surface structure against which the spring biased cam follower bears during motion of the carrier portion relative to the vehicle mount portion; and wherein as the carrier portion swings toward or away from the vehicle mount portion it is retained in one or more intermediate locations between a fully open and a fully latched position.

18. The article carrier assembly of claim 13, wherein the latch subassembly includes a slam latch including the locking pin wherein the locking pin is an elongated spring biased pin, the latch handle configured to move the elongated spring biased pin from the locked position to the unlocked position, and a locking guide device that has opposing ramps of elastic arms for receiving an elongated component of the upwardly oriented arm portion.

19. The article carrier assembly of claim 13, wherein the latch subassembly includes:
the latch handle being carried by a cover of the upwardly oriented arm portion and being connected to the locking pin;
the engagement projection being fixed relative to the locking pin;
wherein the latch handle, the locking pin, and the engagement projection are rotatable between a locked position and an unlocked position about a pin axis;
wherein the engagement projection of the locking pin creates an interference with a slot of the vehicle mount portion when in the locked position;
wherein the engagement projection of the locking pin does not create an interference with the slot of the vehicle mount portion when in the unlocked position;
and wherein the latch subassembly further includes a locking guide device that has opposing ramps of elastic arms for receiving an elongated component of the vehicle mount portion.

20. The article carrier assembly of claim 1, wherein the article carrier assembly is adaptable for use on a vehicle that is reconfigurable between a pickup truck configuration and a sport utility vehicle configuration, the vehicle comprising:
a frame comprising a front region that is located generally over a pair of front wheels of the vehicle and a rear region that is located generally over a pair of rear wheels of the vehicle, the rear region having a pair of opposing bed walls and a rear floor, wherein the frame comprises one or more frame fastening devices;
a rear enclosure assembly configured to attach to the one or more preexisting fasteners on the frame to reconfigure the vehicle from the pickup truck configuration to the sport utility vehicle configuration, the rear enclosure assembly comprising:
i) a roll bar assembly comprising a hoop structure having a pair of spaced apart pillars, an upper cross bar connected to upper regions of the pillars; and
ii) one or more rear passenger seats configured for attachment to the roll bar assembly;
wherein the hoop structure is attached to the opposing bed walls and/or the rear floor of the frame.
